(19) United States
(12) Patent Application Publication
(10) Pub. No.: US 2012/0191270 A1
(43) Pub. Date: Jul. 26, 2012

(54) Wireless towed vehicle light conditions communication application

(75) Inventor: Raymond E. Floyd, Cody, WY (US)

(73) Assignee: Raymond Floyd, Cody, WY (US)

(21) Appl. No.: 13/011,962

(22) Filed: Jan. 24, 2011

(51) Int. Cl. G06F 17/00

(52) U.S. Cl. 701/2

(57) ABSTRACT

An application program to provide control for a radio frequency link for towed vehicle light and brake control, matching conditions of the towing vehicle. These include turn signal, brake signal, and running lights, and an analog signal for the towed vehicle electric brakes. The towing vehicle contains signal sensors and conditioners, which are converted into a data string, modulated, and transmitted using a continuous wave radio frequency carrier. The towed vehicle contains a receiver and demodulator, which extracts the data, and passes it to the towed vehicle microprocessor. The microprocessor also converts the electric brake digital data into an analog signal to apply the towed vehicle electric brake.

### FIELD OF THE INVENTION

This invention relates to an application program used to provide wireless communication between a towing vehicle and a towed vehicle, in particular for communicating signal lights and electric brake conditions from the towing vehicle to the towed vehicle.

### BACKGROUND

Historically, utility trailers and stock trailers have used a multi-pin connector on the powered vehicle, connected via a multi-wire cable to the towed vehicle. The number of wires may vary according to the manufacturer of the cable connectors, but most common systems today use 5 to 7 wires to conduct signals for turn signals, brake lights, and running lights (including tail lights) for utility trailers and an additional function for stock trailers—electric brakes.

There are a number of problems which can be associated with the current method of signal connection, including; 1) pin retraction on the powered vehicle connector, 2) bent or broken pins on the trailer connector, 3) broken wires on the trailer cable and/or vehicle connector, 4) noisy or poor connections within the vehicle or trailer connector, 5) water and dirt accumulation on either the powered vehicle or towed vehicle connector, and 6) breakage of the cable and/or connector on the towed vehicle side.

### SUMMARY OF THE INVENTION

In a preferred embodiment, the present invention is the design and implementation of an application program that senses the towing vehicle signal light conditions and the electric brake, if available, converts those analog signals into a data frame configuration, converts the data frame(s) into a radio frequency signal, and transmits that signal to the towed vehicle. The towed vehicle receives the radio frequency signal, demodulates the received signal into a digital packet, and finally converts the digital packet into the specific signals to energize the appropriate running lights and electric brake.

### BRIEF DESCRIPTION OF THE DRAWINGS

FIG. 1 is the general layout of the preferred embodiment of the light control application including the towing vehicle and towed vehicle components.

FIG. 2 is a detailed layout of the preferred embodiment of the light control application in the towing vehicle.

FIG. 3 is a detailed layout of the preferred embodiment of the light control application in the towed vehicle.

FIG. 4 is a detailed flow diagram of the preferred embodiment of the light control application in the towing vehicle.

FIG. 5 is a detailed flow diagram of the preferred embodiment of the light control application in the towed vehicle.

FIG. 6 is a detailed layout of the data packet used in the light control application in the preferred embodiment.

### DETAILED DESCRIPTION OF THE PREFERRED EMBODIMENT

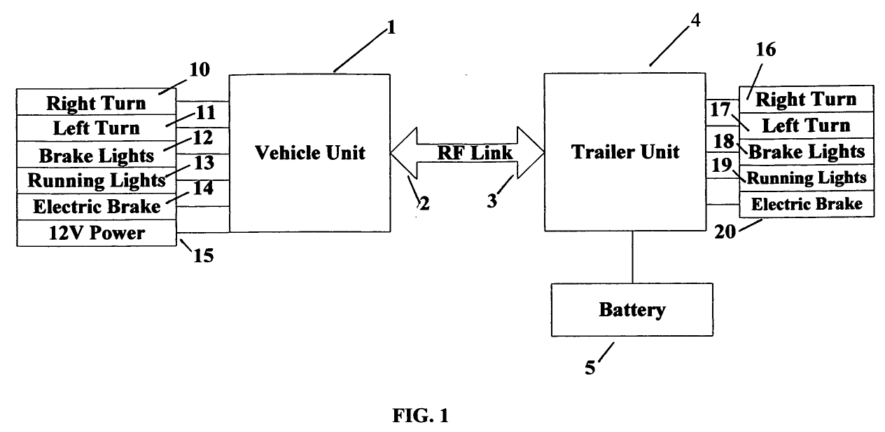

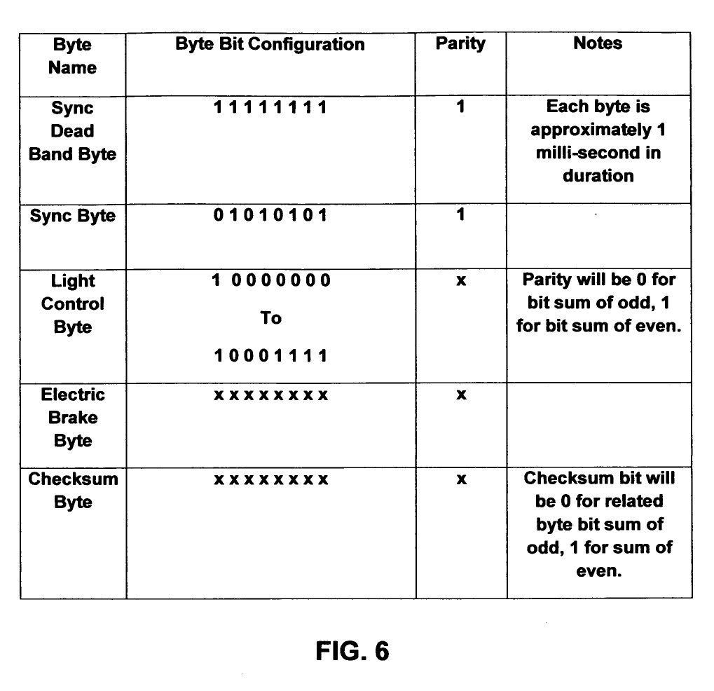

A novel approach suggested in USPTO Patent Publication 2005/0258947, by Kunianski, would employ a radio frequency (RF) link between the powered unit and the towed vehicle. The power of the RF link would be expected to be less than 1 watt, and operate at a frequency between 125 KHz and 900 MHz, depending on the system parameters required. It would be a line-of-sight system, expected to work over a range of 3 to 8 feet, with dirt, mud, snow, ice, etc. not being a hindrance to proper operation. A block diagram of the system is illustrated in FIG. 1, which includes the electric brake 14 found on stock trailers. The vehicle unit 1 provides the signal processing, data conversion, and RF signal necessary to communicate the desired signals to the trailer device 4. The inputs to the vehicle unit 1 include right turn signal 10, left turn signal 11, brake light signal 12, running lights on signal 13, electric brake signal 14, and power 15. The output of the vehicle unit 1 is a modulated multi-byte data unit as defined in the application program developed as the preferred solution, where the first byte is a header byte with a preferred value of 11111111 (FF hex), the second is a synchronization byte with the preferred value of 01010101 (55 hex), the third is the light conditions to be activated on the trailer with the preferred value ranging from 10000000 to 10001111 (80 to 8F hex), the fourth byte has 8 bits of analog value for the setting of the electric brake (if applicable) with the preferred value ranging from 00000000 to 11111111 (00 to FF hex), and the fifth byte is a odd checksum for the prior 4 bytes with the bit configuration determined by the bit sum (base 2) of the corresponding bit position of the prior four bytes. The byte configurations are illustrated in FIG. 6. Additional bytes could be added for other functions not yet defined. As additional bytes are assigned functions, the checksum byte would remain as the last in the data sequence. The modulated signal is transmitted from the vehicle unit 1 via the antenna 2.

The trailer unit 4 receives the RF signal on its antenna 3, synchronizes with the incoming signal, and then provides outputs to the right turn signal 16, the left turn signal 17, the brake lights 18, the running lights 1), or an analog signal to the electric brake 20. The output signals, with the exception of the electric brake, may be latched within the trailer unit as long as the bit is set active in the incoming data string, or, due to the high rate of data transfer, remain energized until the next data string is processed. The trailer unit is powered from a +12V battery 5, which has the charge maintained by a variety of possible sources as suggested by Kunianski (not shown) including; 1) an optional 12V cable from the powered vehicle, an external trickle charge provided by a solar cell assembly, wind generator, axle alternator or similar power generation device, or an external AC power cord input through a charger controller when the vehicle is stationary.

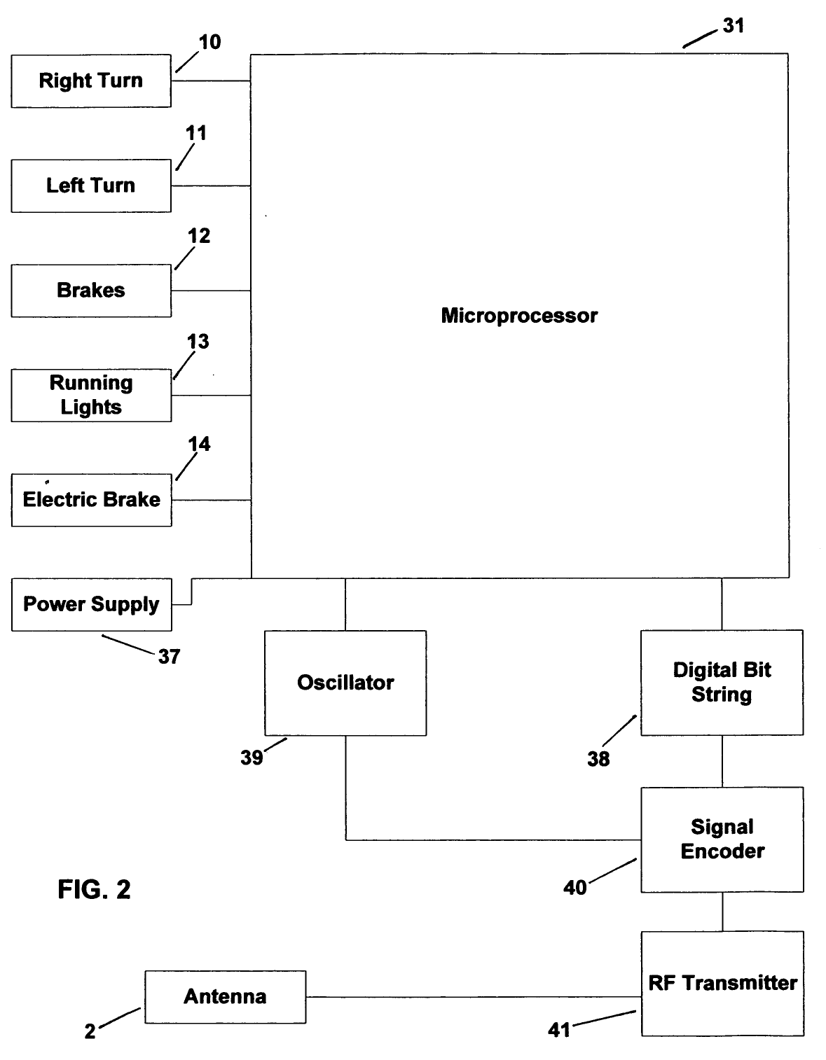

FIG. 2 illustrates the general concept of the vehicle unit 1. The signals for right turn 10, left turn 11, brake lights 12, running lights 13, and electric brake 14 are input to an analog to digital converters (not shown). All of these signals are fed into the microprocessor 3) where the data stream packet will be formed. Power for the unit is supplied by the vehicle, which is fed into the power supply 37 for proper voltage supply for microprocessor and other circuit components operation. The microprocessor has an input from the oscillator 39 for timing purposes. The data packet out of the microprocessor 31 is coupled to a digital to analog unit 38, and then to the signal encoder 40 where the signal is modulated into the signal to be fed into the RF unit 41. The RF unit primary frequency is modulated by the data string, and coupled to the output via the antenna 2, where it is transmitted in the general direction of the towed vehicle.

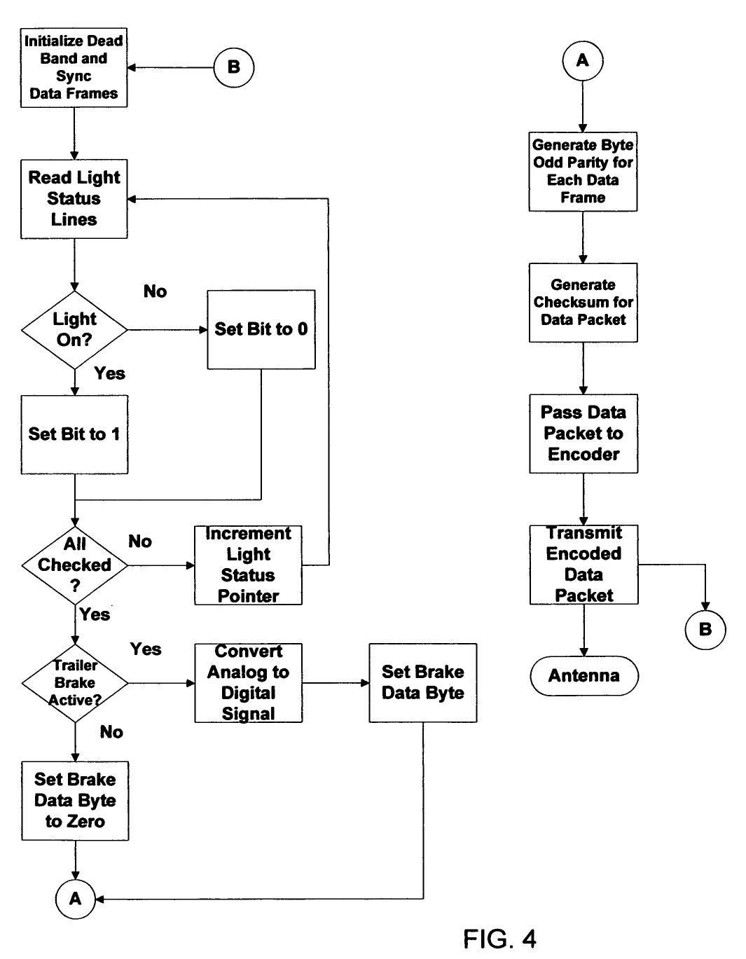

FIG. 4 illustrates a preferred implementation of the application program to control the data packet content within the framework of the towing vehicle microprocessor 1. As the dead band and synchronization bytes are fixed in this implementation, they are set to 88 hex and 55 hex respectively (as previously described). The application will then determine the status of the light signals 10 through 13, and set the corresponding bit in the light control byte, byte three of the data packet. The light control byte may have a variety of bit configurations ranging from 80 hex (no light signals active) to 8F (with all light signals active—a possible condition with running lights, brake lights, and turn signal lights set as flashers). The particular bit affinity to signal is an implementation choice and not considered critical to the application. After the light control byte has been set, the application senses the status of the electric brake, if applicable. If there is an analog value sensed, the analog signal will be converted to a digital equivalent and that data placed into the fourth data byte of the data packet. If there is no electric brake in the system or the brake analog value is zero, the fourth data byte of the data packet will be cleared to zero (00 hex).

Once the data bytes have been formed, the application will generate odd parity for each byte (the parity could be even or eliminated, an implementation choice), and the checksum byte for the entire data packet (including the required odd/even/none parity for the checksum byte itself). The five byte data packet will then be passed to the encoder, and then to the transmitter for transmission via the antenna. The application will then loop to the beginning of the process to again check the status of the lights. The loop process could be delayed if necessary to meet transmitter heating or other restrictions, but would be expected to occur no less than every 150 milliseconds to ensure the light outputs meet human visual continuity requirements. The application could also be timed to loop through the data packet build process only if a change in a light status was detected, i.e. a turn signal was activated and then went off (or into its blink cycle).

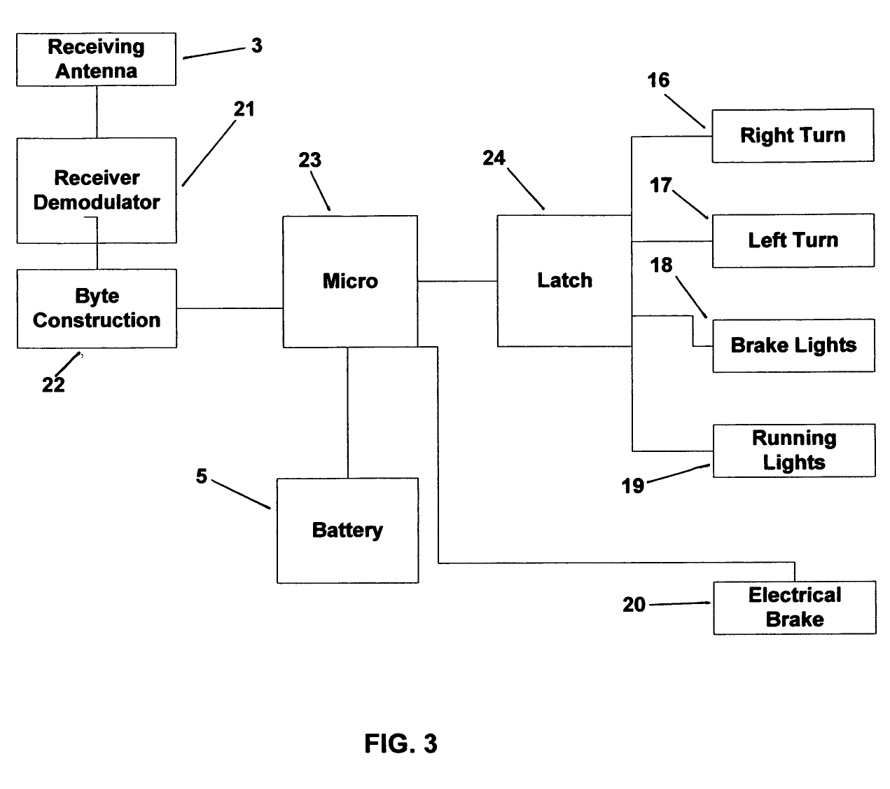

FIG. 3 illustrates the general concept of the trailer unit 4 as suggested by Kunianski. The received RF signal is accumulated by the receiving antenna 3, and fed into the receiver-demodulator 21 The output of the demodulator 21 is fed to a byte construction unit 22 which converts the incoming bit string into the 5 byte data string, which is then passed to the controlling microprocessor 23. Once synchronization is achieved by the microprocessor 23, the dead band and synchronization bytes are stripped from the data string. The third byte, the light control byte, is mapped to the appropriate latch 24, which then sets the appropriate conditions for right turn 16, left turn 17, brake lights 18, and running lights 1). Because of the high rate of data transfer, the latch circuits could be eliminated. The microprocessor 23 also feeds the fourth byte to a digital-to-analog conversion unit, which feeds the analog voltage to the electric brake 20. The unit receives power from the trailer battery 5, which has a maintaining trickle charge which may be supplied by one, or more, ways (not shown); 1) from an optional battery cable from the towing vehicle, 2) from a solar panel, axle alternator or wind generator, or 3) from an external 115VAC fed through an AC/DC conversion unit.

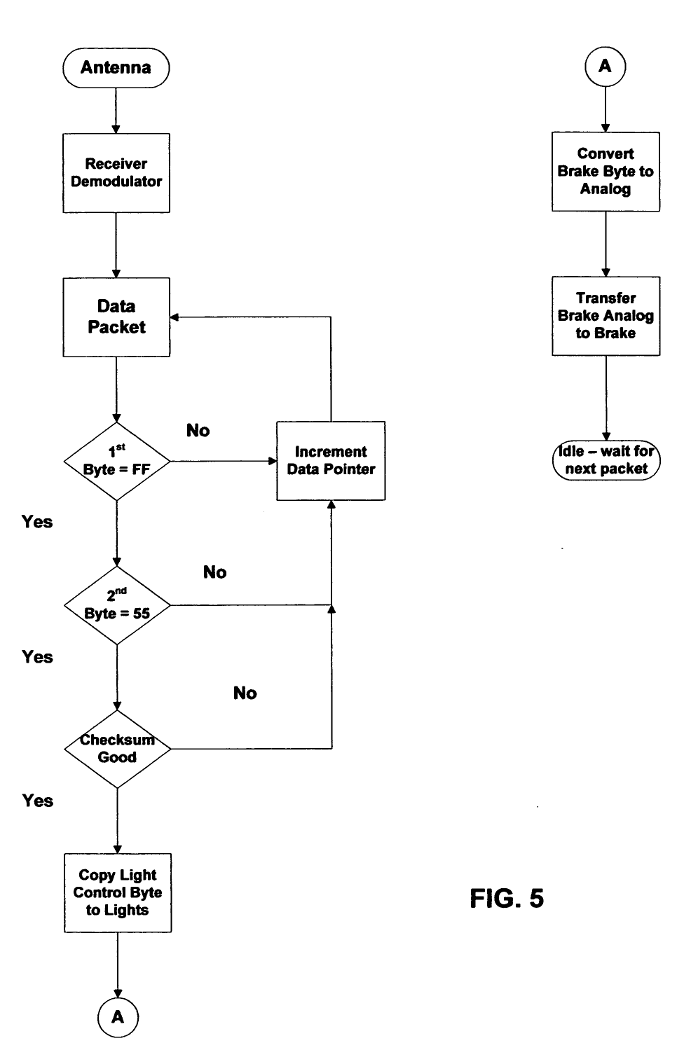

The towed vehicle application, reference FIG. 5, will demodulate the incoming radio frequency signal, placing each byte of the data packet into a work storage area. The application will search for the dead band byte of FF hex, including good odd parity (or even or none as implemented by the design requirements), followed by the synchronization byte of 55 hex (again inclusion of good parity check). The sequence of FF hex followed by 55 hex signifies the start of the data packet. Other choices of synchronization byte content are possible as a design choice. The application program will then form the expected checksum for the data packet, and verify that the calculated checksum and the data packet checksum are the same. If the checksum does not validate, the program will return to the input data packet process and wait for the next data packet arrival.

If the checksum is found to be correct, the application program will copy the light control byte to the lights (or light latches as implemented by the vehicle design). The light status will remain in the commanded condition until the next valid data packet is processed. The electric brake byte will be converted from a digital value to an analog value and placed on the electric brake signal line (if included in the vehicle system). The application will then idle, awaiting the next data packet decode.

The expected signal sequence is illustrated in FIG. 6. The sync dead band byte is a hex 88, followed by the sync byte, a hex 55, a unique bit pattern used as a synchronization byte to ensure the trailer unit 4 is interpreting the incoming command string accurately.

The third byte, which contains the light pattern (or lights to be energized on the trailer), with bit 0 set to a 1 and the following 3 bits set to 0 (a hex 8×). Bit 4 will be set to 1 when BRAKE is active, 0 otherwise. Bit 5 will be set to 1 when RUNNING LIGHTS is active, 0 otherwise. Bit 6 will be set to 1 when RIGHT TURN is active, 0 otherwise. Bit 7 will be set to 1 when LEFT TURN is set to 1, 0 otherwise. As some actions, such as emergency flashers, can force conditions where a turn signal need not be pressed to result in a RT and LT signal illumination, there are codes to allow for these circumstances, and will be controlled by the microprocessor.

The fourth byte contains the analog value to be applied to the electric brake on the trailer, if the brake is attached. All bit conditions are permitted, and will take on the bit value to be applied to the electric brake, thus allowing the brake sensitivity to be divided into a range of unique values.

The fifth byte is the data packet checksum, formed by the bit sum of the four preceding byte bits, modulo 2.

What is claimed is:

1. An application program consisting of two parts for sensing of light signals in a towing vehicle, encoding said light signal conditions into a data packet, transmitting said packet via a radio frequency signal. The transmitted signal will be received by the towed vehicle, demodulated, and used to set lighting conditions on the towed vehicle lights.

2. An application program for a wireless light control system for towing vehicles; the application comprising:
signal condition sensing;
data packet build;
byte parity generation;
data packet checksum generation;
data packet encoding;
radio frequency signal modulation; and
radio frequency transmission.

3. The towing vehicle application of claim 2, wherein the conditioned light signals are coded into a signal appropriate to the conditions of lights to be processed; the signals comprising:
synchronization control bytes;
a light control byte for the light conditions (turn, brake, running);
a digital equivalent for the electric brake;
a data packet checksum.

4. The towing vehicle application of claim 2, wherein the encoded signal is processed and transmitted on a regular timed basis, not less than once every 150 milliseconds.

5. The towing vehicle application claim 2 that provides electric brake information:
as part of the towing vehicle braking action; or
as a function of the towing vehicle operator manual brake operation.

6. An application program for a wireless light control system for towed vehicles; the application comprising:
a radio frequency receiver;
a radio frequency signal demodulator;
a data packet reconstruction methodology;
a data byte process and recognition methodology;
a signal output process;
a byte parity detection system; and
a data packet checksum detection system.

7. The towed vehicle application of claim 6, wherein the receiver and demodulator converts the radio frequency signal into a digital data packet.

8. The towed vehicle application of claim 6, which synchronizes the incoming data stream for signal processing.

9. The towed vehicle application of claim 6, which sends appropriate signals to the signal conditioners to activate the selected lights (turn, brake, running).

10. The towed vehicle application of claim 6 will provide an analog signal proportional to the brake signal provided by the towing vehicle for application of the electric brake on the towed vehicle.

11. The towed vehicle application of claim 6 will provide parity checks for each byte of the data packet.

12. The towed vehicle application of claim 6 will provide a checksum check for the entire data packet.
